(19) United States
(12) Patent Application Publication
(10) Pub. No.: US 2016/0059535 A1
(43) Pub. Date: Mar. 3, 2016

(54) CONDUCTIVE BOND FOILS

(71) Applicant: Materion Corporation, Mayfield Heights, OH (US)

(72) Inventors: Richard J. Koba, Saugus, MA (US); James Fraivillig, Austin, TX (US)

(21) Appl. No.: 14/839,536

(22) Filed: Aug. 28, 2015

Related U.S. Application Data
(60) Provisional application No. 62/064,117, filed on Oct. 15, 2014.
(60) Provisional application No. 62/043,914, filed on Aug. 29, 2014.

(51) Int. Cl. B32B 37/14; H01B 1/22; B29C 65/00; B32B 7/12; B32B 37/16; B29C 65/02; C09K 5/14; B32B 7/02

(52) U.S. Cl. CPC B32B 37/144; C09K 5/14; H01B 1/22; B32B 7/02; B32B 7/12; B32B 37/16; B29C 65/02; B29C 66/45; B29C 66/712; B29C 66/7392; B29C 66/73112; B32B 2457/00; B32B 2307/202; B32B 2264/108; B32B 2264/105; B32B 2037/1253

(57) ABSTRACT

A bond film includes a thermoplastic polyimide adhesive that contains particles which are thermally conductive and electrically conductive particles. A conductive foil layer may be placed between two layers of adhesive to form the bond foil. This bond film has a low curing temperature which reduces CTE mismatch between different substrates and therefore allows direct bonding of substrates that have high coefficient of thermal expansion mismatch. The low curing temperature also allows for reduced processing costs. The conductive bond film does not degrade at high temperatures, allowing for service temperatures up to 350° C. and thermal excursions up to 450° C.

### CROSS-REFERENCE TO RELATED APPLICATIONS

This application claims priority to U.S. Provisional Patent Application Ser. No. 62/043,914, filed on Aug. 29, 2014, and to U.S. Provisional Patent Application Ser. No. 62/064,117, filed on Oct. 15, 2014. The disclosures of these applications are hereby fully incorporated by reference in their entirety.

### BACKGROUND

The present disclosure relates to a bond foil that is thermally and electrically conductive. The bond foil includes an adhesive bond film formed by filling a thermoplastic polyimide with particles that are thermally conductive and electrically conductive materials. The disclosure also relates to the use of such bond foils to produce articles made from bonding two different substrates that have different coefficients of thermal expansion.

A die is a semiconductor on which a circuit is formed. A silicon (Si) die can reliably operate long term at an upper temperature limit of about 200° C. For high temperature applications where the die is exposed to temperatures over 250° C. for extended time periods, wide bandgap semiconductors (e.g. silicon carbide (SiC), gallium nitride (GaN)) are being increasingly used.

It would be desirable within the power semiconductor industry to be able to bond large-area Si, SiC, or GaN dice directly onto copper or aluminum heatsinks to save cost and minimize thermal resistance. Using conventional solders (e.g. gold-tin (AuSn) or silver-tin-copper (AgSnCu) solders), a direct solder attachment would result in fracture of the semiconductor chip or voiding in the solder joint due to severe coefficient of thermal expansion (“CTE”) mismatch between the heatsink and the semiconductor chip. The CTE of most semiconductor substrates such as Si, SiC, and gallium arsenide (GaAs) is low (e.g. silicon has a CTE of 2.6 ppm/° C., SiC of 2.2 ppm/° C., GaAs of 6.86 ppm/° C.) while the CTE of aluminum and copper are high (e.g. copper has a CTE of 17.9 ppm/° C., aluminum of 22.2 ppm/° C.). Presently, low CTE materials like ceramics and metal matrix composites are interposed between the chip and the heatsink in order to minimize the CTE mismatch between the chip and the Al or Cu heatsink. These interposed materials increase thermal resistance, increase the volume of the assembly, and add cost.

It would be desirable to provide a conductive material that can be used to join together two substrates having very different coefficients of thermal expansion.

### BRIEF DESCRIPTION

The present disclosure relates to fabrication of a thermally conductive and electrically conductive bond foil. This bond foil can be used in applications where there is a need for high thermal conductivity (e.g., >2 W/m-K) and high electrical conductivity (e.g., >2000/Ω-cm), mechanical compliance, and high temperature (up to 350° C.) continuous operation. The bond foil generally includes a conductive foil layer and one or two layers formed from a bond film that acts as an adhesive.

Disclosed in various embodiments are conductive bond foils comprised of a bond film. The bond film comprises particles dispersed in a polyimide, the particles being thermally conductive and electrically conductive.

In particular embodiments, the polyimide is a thermoplastic polyimide.

The thermally conductive and electrically conductive particles may be made from a material selected from the group consisting of silver, gold, graphene, copper, covetic copper, graphite, and carbon nanotubes. The thermally conductive and electrically conductive particles can be in the form of powder, flakes, needles or fibers or combinations thereof.

In desirable embodiments, the bond film is B-staged.

The conductive bond foil may be in the form of a sheet, a ribbon, or a stamped preform. The conductive bond foil may have a total thickness of from about 10 micrometers (μm) to about 500 micrometers.

In some embodiments, the conductive bond foil further comprises a conductive foil layer coated on opposite sides with the bond film. The conductive foil layer can be made from a metal selected from the group consisting of graphite, silver, copper, covetic copper, aluminum, gold, palladium, and alloys thereof. Sometimes, the conductive foil layer is formed from a set of sublayers, for example when a metal sublayer is plated with other metal sublayers. In other embodiments, the conductive foil layer is formed from a polyimide film filled with particles selected from the group consisting of graphite, carbon nanotubes, graphene, copper, and silver; and wherein the particles in the polyimide layers of the conductive foil layer are different from the particles in the bond film. In some specific embodiments, the conductive bond foil has a total thickness of from about 10 μm to about 500 μm, and the thickness of the bond film on each side of the conductive foil layer is from about 1 μm to about 20 μm.

Also disclosed herein are methods of joining a first substrate to a second substrate, comprising: placing a conductive bond foil between the first substrate and the second substrate; applying pressure to join the first substrate to the second substrate; and curing the bond film; wherein the conductive bond foil comprises a bond film formed by dispersing particles in a polyimide, the particles being thermally conductive and electrically conductive.

In some embodiments, the first substrate is a semiconductor die or a ceramic, and the second substrate is a flange or a heatsink. In other embodiments, the first substrate is a sputter target, and the second substrate is a backing plate. In still other embodiments, the first substrate is an organic printed circuit board, and the second substrate is a flange or a heatsink. In yet other embodiments, the first substrate is a lid, and the second substrate is a flat seal ring.

In particular embodiments, the difference between the coefficient of thermal expansion of the first substrate and the coefficient of thermal expansion of the second substrate is at least 5 ppm/° C.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic exploded cross section of a first substrate bonded to a second substrate using a conductive bond film. The conductive bond film does not contain a conductive foil layer. The bond film is an adhesive that is filled with particles which are thermally conductive and electrically conductive.

FIG. 2 is a schematic exploded cross-section of a first substrate bonded to a second substrate using a conductive bond foil. The conductive bond foil here is formed from a conductive foil layer and an adhesive layer (i.e. bond film) on each side of the foil layer.

FIG. 3 is a schematic exploded view of a lid attached to a flat seal ring using the conductive bond foil of the present disclosure.

FIG. 4 is a metallographic cross-section of a conductive bond foil of the present disclosure.

FIG. 5 is a metallographic cross-section of a conductive bond foil joining a silicon die and an aluminum plate.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named components/steps and permit the presence of other components/steps. However, such description should be construed as also describing compositions or processes as “consisting of” and “consisting essentially of” the enumerated components/steps, which allows the presence of only the named components/steps, along with any impurities that might result therefrom, and excludes other components/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.”

As used herein, the term “coefficient of thermal expansion” or “CTE” refers to the linear coefficient of thermal expansion at 20° C.

A “mil” is one-thousandths of an inch.

The term “graphene” refers to an allotrope of carbon in the form of a planar sheet of sp²-hybridized bonded carbon atoms that are arranged in a hexagonal honeycomb crystal lattice. This sheet is exactly one atom in thickness, so that each atom can be considered a surface atom. A graphene sheet has a height or thickness of about 0.7 nm.

The term “graphite” refers to layers of graphene which are held together by Van der Waals forces. The distance between adjacent layers of graphene is 0.335 nm. Graphite differs from graphene in having lower electrical conductivity.

The present disclosure relates to conductive bond foils. The bond foil includes an adhesive bond film that is mixed with particles that are thermally conductive and electrically conductive. The bond film can be cured at temperatures of less than 300° C. However, after curing, the conductive bond film can withstand extended operation at temperatures higher than the curing temperature. The conductive bond foil can be used to join together different substrates into an article that has reduced thermal stress. Manufacturing processes using the conductive bond foil are also lower in cost than methods utilizing nanosized silver particle.

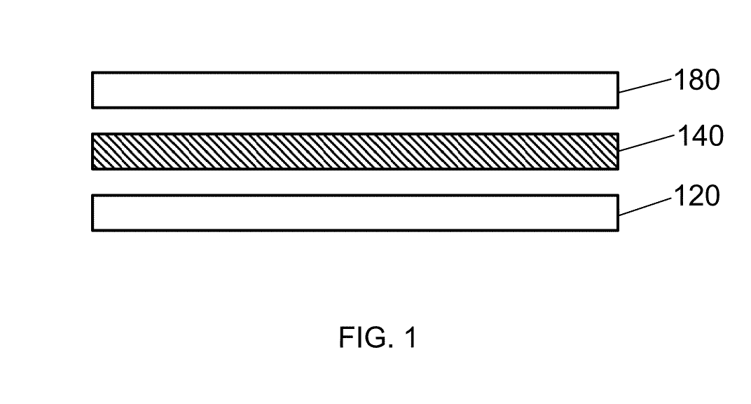

FIG. 1 is an exploded cross-sectional view of an exemplary embodiment of the present disclosure. Here, a heatsink 120 is bonded to an organic printed circuit board 180 using a conductive bond film 140. The bond film 140 is located between the heatsink 120 and the printed circuit board 180. The conductive bond film 140 does not include a conductive foil. The conductive bond film is made from the combination of a polyimide and particles. The particles are thermally conductive and electrically conductive. Pressure is applied to join the three layers together, and they are then exposed to high temperature to cause curing of the bond film.

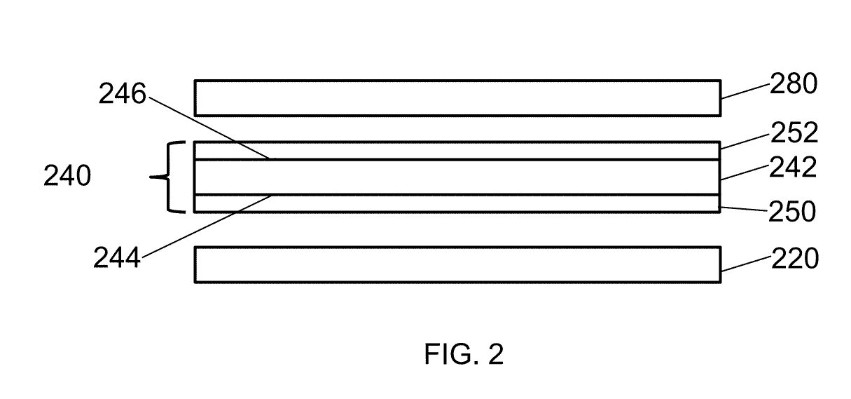

FIG. 2 is another embodiment of the present disclosure. Here, a heatsink 220 is bonded to a semiconductor die 280 using a conductive bond foil 240. The conductive bond foil is formed from a conductive foil 242 having two opposite surfaces 244, 246. The bond film is coated on the two opposing surfaces of the conductive foil, and acts as an adhesive. Put another way, two bond film layers 250, 252 are present on opposite sides of the conductive foil 242. Again, the bond film is made from a polyimide having thermally conductive and electrically conductive particles dispersed therein.

The overall conductive bond foil is thermally conductive and is electrically conductive. The conductive bond foil may have a total thickness of about 2 micrometers (μm) to about 150 μm, or from about 8 μm to about 125 μm, or from about 10 μm to about 500 μm. The conductive bond foil includes a bond film that is formed from (i) a polyimide or thermoplastic polyimide mixed with (ii) particles that are thermally conductive and electrically conductive particles. Most desirably, a thermoplastic polyimide is used. Thermoplastic polyimide provides a fast-acting bond and is suitable for high temperature operations. It is noted that polyimides intrinsically are thermal insulators and do not conduct heat very well. Polyimides are also intrinsically electrically isolating, i.e. they do not conduct electricity.

The particles in the bond film are made of a material that is thermally conductive and electrically conductive. Non-limiting examples of such materials include silver, gold, graphene, copper, covetic copper, graphite, and carbon nanotubes. In this regard, covetic copper is copper which has bonded chemically with nanocarbon structures, and is available from Third Millenium Materials LLC. These materials/particles may be in the form of powders, flakes, needles or fibers, or mixtures thereof, as may be appropriate. Specific examples include silver powder, silver flakes, silver needles, copper powder, copper flakes, and graphite fibers. These thermally conductive and electrically conductive particles render the adhesive bond film and the overall conductive bond foil both thermally conductive and electrically conductive. The particles may be present in an amount of from greater than 0 to about 80 weight percent of the bond film, including from about 10 to about 75 weight percent. Desirably, the particles are homogeneously dispersed throughout the polyimide.

The bond film can be an A-stage adhesive, in which the polyimide is still liquid and a relatively significant amount of solvent is still present. However, in more desired embodiments, the bond film is B-staged, i.e. the majority of solvent has been previously removed and the bond film is uncured, but can be handled and shaped relatively easily. The B-stage bond film can be stamped into shapes.

As illustrated in FIG. 2, the conductive bond foil can be formed by coating two opposite sides of a conductive foil layer with the bond film containing a thermoplastic polyimide and particles that are thermally conductive and electrically conductive. The conductive foil layer itself can have a thickness of from about 0.5 mils (13 μm) to about 10 mils (250 μm). In particular embodiments, the thickness of the bond film layers (250, 252) on each side of the conductive foil layer is from about 1 μm to about 20 μm.

In some embodiments, the conductive foil layer can be made from a metal, such as silver, copper, covetic copper, aluminum, gold, palladium, or high conductivity alloys of these metals. These metals are thermally conductive and electrically conductive as well. In some embodiments, the conductive foil layer is formed from a set of sublayers. For example, a copper sublayer can be clad or plated with aluminum, silver, gold, nickel, or palladium sublayers on both sides to render the overall conductive foil layer resistant to corrosion. Electrically conductive bulk alloys that are corrosion resistant include gold, certain silver alloys, and 5000-series aluminum. For most applications, the metal foil should be as soft and ductile as possible in order to promote a compliant interface between the two surfaces to be bonded using the conductive bond foil.

Alternatively, the conductive foil layer can be formed from an organic plastic foil that is filled with particles that are thermally conductive and electrically conductive. Examples of such organic plastic films include polyimide films. The particles present in the conductive foil layer can be materials such as graphite (e.g. pyrolytic graphite), carbon nanotubes, graphene, copper, and silver. Again, these particles can be in the form of powders, flakes, needles or fibers, as may be appropriate. The particles in the conductive foil layer are different from the particles in the bond film.

The use of a thermoplastic polyimide (“TPI”) filled with thermally conductive and electrically conductive particles as the adhesive in the bonding layer (i.e. the bond film) provides several advantages. First, this adhesive will bond well to most ceramic, metal, or glass surfaces without requiring pre-metallization of that surface. The high adhesive strength of cured TPI coupled with the thermally conductive and electrically conductive particles should minimize the contact resistance between the conductive bond foil and the surface/substrate to which it is mated. Cured TPI is also very compliant, i.e. has a low Young's modulus or is not very stiff. The combination of high adhesive strength with low stiffness means that cured TPI bond films can withstand severe shear stress without fracture or loss of adhesion. The cured TPI bond film can also withstand severe CTE mismatch between two surfaces being bonded together without losing adhesion to either surface.

Second, this adhesive will cure at temperatures below 300° C. This reduces residual stress (CTE mismatch) between the substrates being bonded that results from the high temperatures needed for direct bond copper (1070° C.) or active metal braze (825° C.) and the subsequent cooling down to room temperature. This low temperature cure also reduces processing costs since lower-cost ovens or hot plates can be used instead of expensive high temperature furnaces.

Another advantage is that this adhesive can be operated far above its curing temperature without degrading. This permits higher operating temperatures in the final substrate, and also allows the articles to withstand higher amperage excursions compared to other adhesives. Once completely cured, the thermoplastic polyimide filled with thermally conductive particles can withstand extended operation at 350° C. and thermal excursions to 450° C. By comparison, epoxy adhesives typically cure at a low temperature of around 170° C., and will debond, char, or delaminate at higher temperatures. As a result, substrates made using the conductive bond film are compatible with subsequent die attach operations using conventional die bonding materials such as silver-filled epoxy, AuSn solder (280° C.), and SnAgCu solder (217° C.).

Yet another advantage that arises is that, due to the reduced residual stress, new pairs of materials can be bonded together using the conductive bond foil than were previously possible. The conductive bond foil can be used in applications where there is a need for high thermal conductivity and high electrical conductivity, mechanical compliance, and high temperature (up to 350° C.) operation. For example, the conductive bond foil can be used to attach semiconductor dice to flanges or heatsinks; ceramic substrates to flanges or heatsinks; sputter targets to backing plates; organic printed circuit boards to flanges or heatsinks; or lids to flat seal rings.

High power semiconductor dice could be attached to metal surfaces that otherwise have severe CTE mismatch. Exemplary semiconductor substrates include silicon, GaAs, freestanding III-V epitaxial layers, SiC, GaN, GaN/sapphire, GaN/ScAlMgO₄, GaN/Si, or GaN/SiC. Metal surfaces may be made of copper, aluminum, or steel. For example, a large (1 in×1 in) semiconductor die could be bonded directly to an aluminum heatsink, or to an anodized aluminum heatsink or flange. Semiconductor dice could also be attached to surfaces having lower CTE values, such as alumina; aluminum nitride (AlN); BeO; and various metal matrix composites such as copper-tungsten; copper-molybdenum; copper-diamond; or aluminum-diamond.

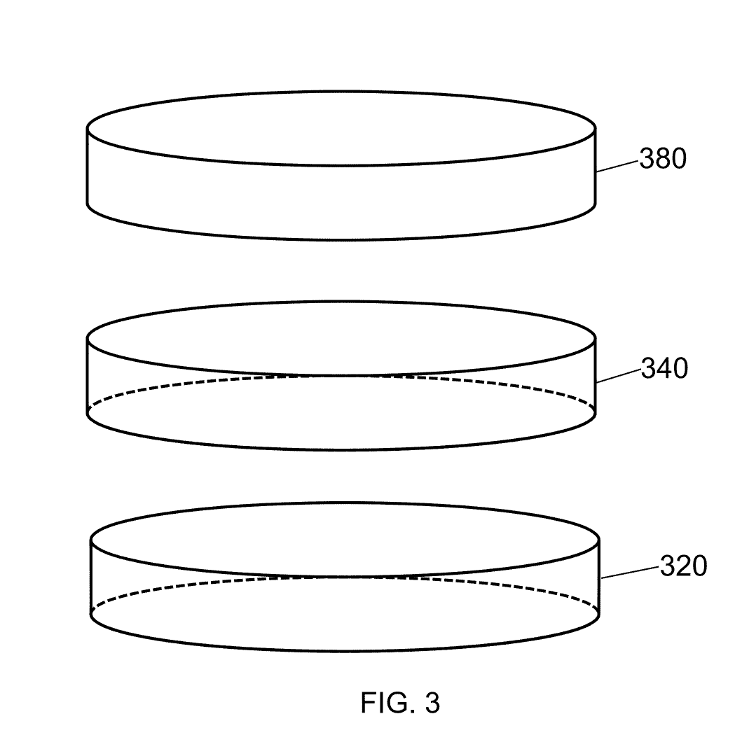

FIG. 3 illustrates the use of a conductive bond foil 340 to bond a lid 380 to a flat seal ring 320. The foil 340 and ring 320 are relatively flat two-dimensional surfaces, as indicated by the dotted line. This can be useful for lid sealing where fine leak hermeticity is not required and the service temperature exceeds 280° C.

The conductive bond foil of the present disclosure can be provided in the form of ribbons or sheets. The conductive bond foil can also be stamped into a preform. In some embodiments, the bond foil may be machined into a desired shape to match the substrate that is being bonded prior to actual bonding. For example, the bond foil may be affixed to a first substrate, and the two layers can then be stamped or cut into a desired pattern. Alternatively, the bond foil and the substrate can be stamped or cut into the desired pattern separately.

In other embodiments, the end product is formed by interposing the conductive bond foil between two substrates, and then curing the adhesive. Subsequently, the substrate and the bond foil may be shaped. In this regard, the thermoplastic polyimide used in the bond film, once fully cured, will resist etching by acids. However, the thermoplastic polyimide can be dissolved in an alkaline solution. This permits the adhesive in the bond film to be selectively removed as desired using an alkaline solution.

The conductive bond foil described herein allows: (1) bonding of a semiconductor chip (or another material with a low CTE) directly to a high CTE material like copper or aluminum with minimal damage to the semiconductor chip, (2) forming a bond between most ceramics and metals without requiring prior metallization of the ceramic surface, (3) forming a bond with low contact resistance to both surfaces being joined, and (4) forming a bond which, after curing, is substantially free of voids and able to withstand a service temperature of up to 350° C.

The most popular conventional material used for die attach is silver filled epoxies. These are comprised of epoxies filled with 20 to 80 weight percent of silver flake, silver needles or silver particles. They are available in single or two component epoxies, and can be offered in the form of pastes or B-staged sheets. In bulk format, their thermal conductivity can range from 3 to 50 W/m-K. However, upon curing, the contact thermal resistance of some silver filled epoxies is high, so that the net thermal resistance of the cured epoxy is much higher than predicted from the bulk thermal conductivity. If there are air voids between the epoxy and the surface it contacts, the thermal contact resistance between the epoxy and the surface will be high. Also, if there is segregation of the silver filler away from the two exterior surfaces during curing, there will a high thermal resistance since silver-free epoxy has a low thermal conductivity. By using a thermoplastic polyimide (TPI) instead of epoxy, the bond films/conductive bond foils described herein should have a lower contact thermal resistance due to the high adhesive strength between TPI and most inorganic surfaces, which should mitigate the formation of voids at the interface.

Other firms such as NBE Tech and Alpha Alent offer die attach materials comprised of nano-sized silver particles. Die attach is performed by applying a moderate amount of pressure and temperature to the die and the nanosilver, thereby sintering the nanosilver into a layer of dense, ductile silver. Again, there is a problem with high contact resistance between the nanosilver layer and the surfaces being joined. Both surfaces contacting the nanosilver layer must be metallized with a noble metal like silver, gold, platinum or palladium in order for the nanosilver to bond to the surface. Another problem with some commercial products is the requirement of high pressure during sintering: typically 750 psi (5200 kPa). Such a high pressure can be problematic with thin, delicate chips or in high volume manufacturing. Thermoplastic polyimide (TPI) layers do not require metallization of the surfaces to be bonded (for example, TPI will form a strong bond to bare Si and bare AlN). Curing of TPI can be achieved under a pressure of only 10 psi (69 kPa). It is believed that a conductive foil layer made of ductile silver should provide the same mechanical and thermal advantages as a layer of sintered/densified silver nanoparticles, albeit at a lower cost.

U.S. Pat. No. 6,015,607 teaches methods to fabricate bond films comprised of TPI adhesive layers bonded on both faces of a polyimide (e.g., Kapton®) carrier film. These bond films offer high adhesive strength to a wide variety of inorganic materials, and are dielectric. However, they are not optimal for die attach applications since the thermal conductivity of bulk polyimide (Kapton®) is only 0.12 W/m-K.

The following prophetic examples are provided to illustrate the conductive bond foils and processes of the present disclosure. The examples are merely illustrative and are not intended to limit the disclosure to the materials, conditions, or process parameters set forth therein.

### EXAMPLE 1

A conductive foil layer can be made of silver (99.99% purity). Silver can be rolled into thicknesses of 37 microns or thinner, and widths of 4 inches to 8 inches. The silver foil can be plated with palladium, or palladium and gold, or nickel and palladium and gold, to provide corrosion resistance and obtain the conductive foil layer. After plating, the temper of the Ag should be as soft as possible.

An A-staged thermoplastic polyimide (TPI) is filled with silver particles to obtain an adhesive (i.e. a bond film) that is thermally conductive and electrically conductive. This A-stage TPI can be coated on both faces of the conductive foil layer. The TPI is then B-staged to obtain the conductive bond foil. As desired, the conductive bond foil can be stamped into preforms. These preforms can then be interposed between two substrates, with pressure and elevated temperature applied in order to cure the bond films and thereby adhere the two substrates together.

### EXAMPLE 2

A conductive foil layer can be made of electrodeposited copper (99.8% purity). Copper is routinely electrodeposited to thicknesses between 12 and 400 μm, and widths of up to 53 inches. Such “ED Cu” is consumed in high volumes by the PC board and flexible circuit industries. The surface roughness of the ED Cu foil can be engineered to have optimal adhesion to polyimide coatings. The bulk microstructure and temper of ED Cu can be engineering to have optimal strength or ductility for this application. Primer coatings are routinely deposited on ED Cu to improve adhesion to subsequent organic coatings such as polyimide. Such primer coatings may be used when appropriate, including coatings such as silane-based adhesion promoters, brass or zinc barrier layers, Zn or Zn—Cr stabilization layers.

A-staged thermoplastic polyimide (TPI) is filled with silver or copper particles to obtain an adhesive bond film that is thermally conductive and electrically conductive. This A-stage bond film can be coated on both sides of the Cu conductive foil layer. The bond film is then B-staged to obtain the conductive bond foil. As desired, the conductive bond foil can be stamped into preforms.

### EXAMPLE 3

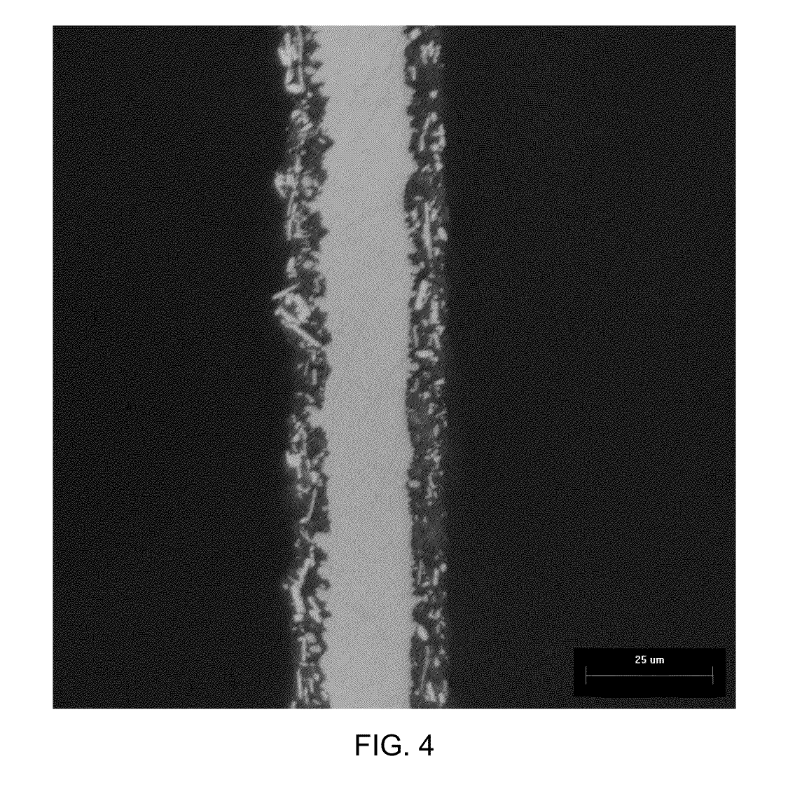

FIG. 4 is a metallographic cross-section of a conductive bond foil of the present disclosure. An electrodeposited copper foil with a thickness of 18 microns is present in the center of this figure. A 10-micron layer of B-staged TPI is bonded on both faces of the copper foil. The TPI contains silver flakes, which are visible in this figure.

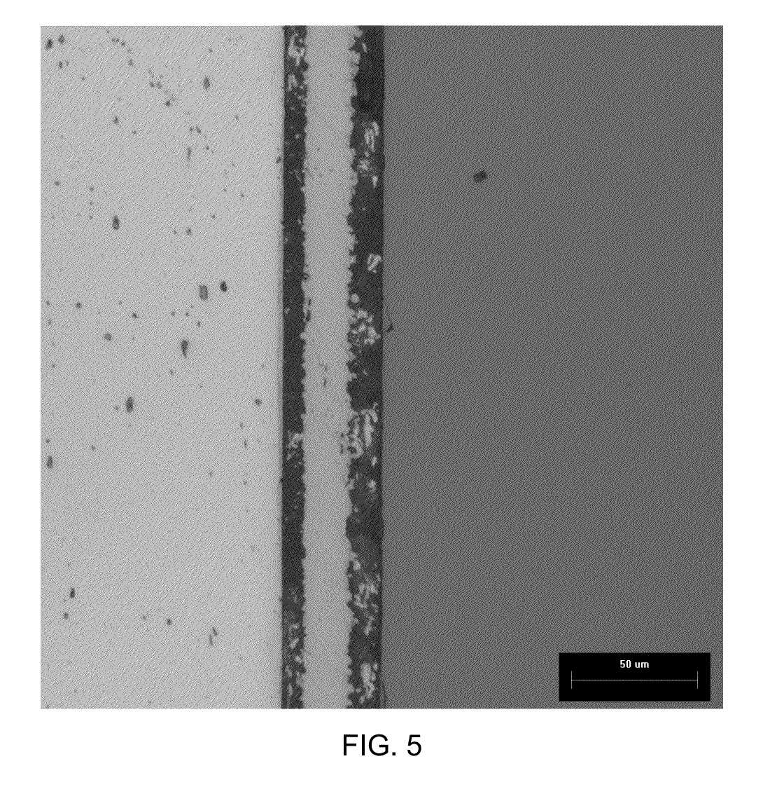

FIG. 5 is a metallographic cross-section of the conductive bond foil joining a silicon die and an aluminum plate. The silicon die is on the right side of the foil, and the aluminum plate is on the left side of the foil. The silicon die has dimensions of 0.14 inch×0.14 inch×0.029 inch (thick), and the aluminum plate has a thickness of 0.13 inches. After curing of the bondfoil, the adhesion between the silicon die and the aluminum plate is excellent. The bonded silicon die passes MIL-STD-833 Method 2019.7 with an average shear strength of 29 kgf (the passing specification is >=2.5 kgf).

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A conductive bond foil comprising a bond film:
wherein the bond film comprises particles dispersed in a polyimide, the particles being thermally conductive and electrically conductive.

2. The conductive bond foil of claim 1, wherein the polyimide is a thermoplastic polyimide.

3. The conductive bond foil of claim 1, wherein the thermally conductive and electrically conductive particles are made from a material selected from the group consisting of silver, gold, graphene, copper, covetic copper, graphite, and carbon nanotubes.

4. The conductive bond foil of claim 1, wherein the thermally conductive and electrically conductive particles are in the form of powder, flakes, needles or fibers.

5. The conductive bond foil of claim 1, wherein the bond film is B-staged.

6. The conductive bond film of claim 1, wherein the conductive bond foil is in the form of a sheet, a ribbon, or a stamped preform.

7. The conductive bond film of claim 1, further comprising a conductive foil layer coated on opposite sides with the bond film.

8. The conductive bond foil of claim 7, wherein the conductive foil layer is made from a metal selected from the group consisting of graphite, silver, copper, covetic copper, aluminum, gold, palladium, and alloys thereof.

9. The conductive bond foil of claim 7, wherein the conductive foil layer is formed from a set of sublayers.

10. The conductive bond foil of claim 7, wherein the conductive foil layer is formed from a polyimide film filled with particles selected from the group consisting of graphite, carbon nanotubes, graphene, copper, and silver; and
wherein the particles in the polyimide film of the conductive foil layer are different from the particles in the bond film.

11. The conductive bond foil of claim 7, wherein the conductive bond foil has a total thickness of from about 10 μm to about 500 μm, and the thickness of the bond film on each side of the conductive foil layer is from about 1 μm to about 20 μm.

12. The conductive bond foil of claim 1, wherein the conductive bond foil has a total thickness of from about 10 μm to about 500 μm.

13. A method of joining a first substrate to a second substrate, comprising:
placing a conductive bond foil between the first substrate and the second substrate;
applying pressure to join the first substrate to the second substrate; and
curing the conductive bond foil by applying heat;
wherein the conductive bond foil comprises a bond film formed by dispersing particles in a polyimide, the particles being thermally conductive and electrically conductive.

14. The method of claim 13, wherein the first substrate is a semiconductor die or a ceramic, and the second substrate is a flange or a heatsink.

15. The method of claim 13, wherein the first substrate is a sputter target, and the second substrate is a backing plate.

16. The method of claim 13, wherein the first substrate is an organic printed circuit board, and the second substrate is a flange or a heatsink.

17. The method of claim 13, wherein the first substrate is a lid, and the second substrate is a flat seal ring.

18. The method of claim 13, wherein the difference between the coefficient of thermal expansion of the first substrate and the coefficient of thermal expansion of the second substrate is at least 5 ppm/° C.

19. The method of claim 13, wherein the polyimide is a thermoplastic polyimide.

20. The method of claim 13, wherein the thermally conductive and electrically conductive particles are made from a material selected from the group consisting of silver, gold, graphene, copper, covetic copper, graphite, and carbon nanotubes.

21. The method of claim 13, further comprising a conductive foil layer coated on opposite sides with the bond film.
